(19) United States
(12) Patent Application Publication
(10) Pub. No.: US 2004/0055831 A1
(43) Pub. Date: Mar. 25, 2004

(54) Arrangement for weight compensating elements

(76) Inventor: Hans M. Huber, Moeriken (CH)

Correspondence Address: WENDEROTH, LIND & PONACK, L.L.P., 2033 K STREET N. W., SUITE 800, WASHINGTON, DC, 20006-1021, US

(21) Appl. No.: 10/469,023

(22) PCT Filed: Jan. 29, 2002
(86) PCT No.: PCT/CH02/00051

(30) Foreign Application Priority Data
Feb. 27, 2001 (EP) 01810200.4

(51) Int. Cl. B66B 7/10

(52) U.S. Cl. 187/412

(57) ABSTRACT

The invention relates to a lift gear with a main cable (4), operating the lift (1) and connecting the same to a counterweight (2), a weight compensating element (7, 8) for stabilising the lift (1) and the counterweight (2) and a lift cable (16) provided for power supply and function control lines for the lift. The aim of the invention is to simplify the construction of the gear and improve the supply and/or data transmission capacity of the lift cable (16), which is achieved by providing each of the lift (1) and the counterweight (2) with an exclusive weight compensation element (7 or 8) and the weight compensation element (7) for the lift (1) is combined with the lift cable (16).

The invention concerns a lift gear with one or several main cables, operating the lift and connecting the same to a counterweight, a weight compensating element for stabilising the lift and the counterweight, as well as a lift cable provided for the power supply and/or function control lines for the lift. The invention further concerns a weight compensating element for the lift that is combined with the lift cable.

Lift gears of this type have long been operated as either person or freight lifts. With systems of this type, according to prior art the lift and the counterweight are positioned in such a way that they are connected to one another via the lift cable as well as via the weight compensating element. As lift and counterweight travel along paths that extend in parallel to one another systems of this type, according to prior art, make it necessary to include diverting rollers for the main cable as well as for the weight compensating element. This necessity of diverting the weight compensating element with the aid of said diverting rollers, or with the aid of a freely suspended mechanism in smaller systems, requires a considerable amount of space as well as a correspondingly complicated and maintenance intensive construction. It is a further disadvantage that vibration can occur within the weight compensating element, as the cable cannot be pulled too tight on the one hand and as it is practically not exposed to any kind of load on the other.

The space which contains the gear system further incorporates the lift cable that provides the power supply and/or the function control line for the lift, whereby the same is routed in the direction of the lift cabin from the periphery of the lift shaft according to its intended purpose. Accordingly the space related layout of the lift cable must be co-ordinated with that of the weight compensating element. In addition the construction of the lift cable, especially with regard to the data transmission capacity of the same, is somewhat limited.

The purpose of the invention is to eliminate these disadvantages and to produce a lift gear of the type already described earlier, which will however require less space, be more simple in its construction, and which will further be easier to operate and be characterised in that it incorporates a larger capacity for the transmission of important monitoring and/or control data and/or a greater power supply capacity.

This task is solved in accordance with the invention by the lift and the counterweight each incorporating at least one internal weight compensating element, whereby the weight compensating element of the lift is combined with the lift cable.

The lift gear according to this invention requires no diverting rollers for the weight compensating element, which effects not only a quite considerable space saving, but also a reduction of the required maintenance effort. Furthermore, the individual weight compensating elements are less susceptible to vibration than those of the construction according to prior art. Lastly, the integration of the lift cable into the weight compensating element of the lift constitutes a considerable advantage not only because it enables an incorporation into one single construction, but also because the same makes possible a construction of the lift cable which supports an increased data transmission and/or power supply capacity due to an increased load-bearing capacity and an increased overall diameter of the same.

According to the invention and in line with a simpler and more vibration free embodiment of the weight compensating element of the said invention, it is of advantage if these take the form of hanging cables whose one end is fixedly connected with the lift, i.e. with the counterweight, and whose other end is fixedly connected with the load-bearing construction of the lift gear or with the shaft wall of the building.

A suitable fitting of the weight compensating element is one that connects the same with the load-bearing construction or with the shaft wall at a height that constitutes the centre point of the lift path, i.e. of the counterweight.

Depending on the individual construction of the lift and the counterweight, the weight compensating elements may be fitted at a central point or offset from the load-bearing construction and fixedly connected with the floor of the lift, i.e. the counterweight.

In order to hold the weight compensating elements with the aid of the correct tension the invention envisages that the weight compensating elements are each equipped with a slidingly affixed and suspended tensioning weight if necessary.

The weight compensating element of the lift that is integrated into the lift cable is constructed in such a way according to this invention that its cross-sectional profile consists of several elements which are disconnectably coupled with one another, of which at least one is equipped with a multitude of individual lines of the lift cable. In this way it will be possible to change the weight compensation and/or the power supply and data transmission capacity of the lift cable if required.

It is of further advantage here if the elements of the weight compensating element can be coupled with one another with the aid of the integrated lift cable, for example with the aid of a groove and spring connection.

Further details and features of the invention will be found in the following description of two embodiments of the same with reference to the drawings, whereby:

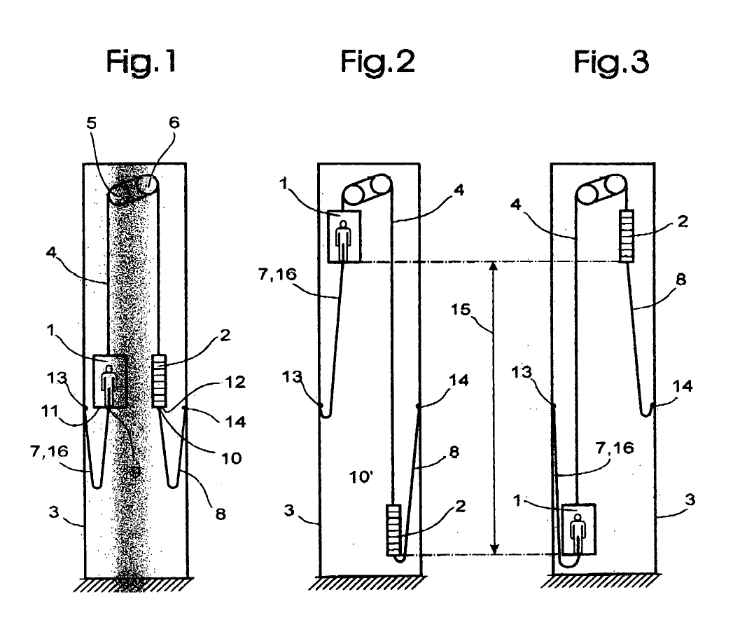

FIG. 1 shows a schematic illustration of the lift gear according to this invention in its central lift position;

FIG. 2 shows the lift gear illustrated in FIG. 1 in its uppermost lift position;

FIG. 3 shows the lift gear illustrated in FIG. 1 in its lowermost lift position;

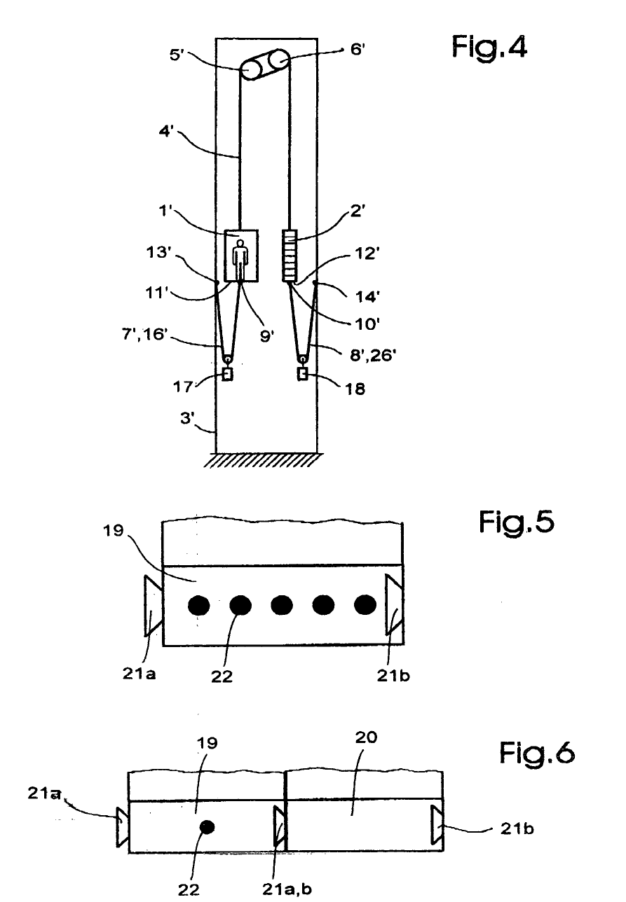

FIG. 4 shows a schematic illustration of a further embodiment of the lift gear illustrated in FIGS. 1 to 3 in the central lift position;

FIG. 5 shows a schematic cross-sectional view of an element of the weight compensating element of this invention with a combined lift cable for the lift that is illustrated in FIGS. 1 to 3, i.e. in FIG. 4; and

FIG. 6 shows two elements of the weight compensating element of this invention with the integrated lift cable that is illustrated in FIG. 5, that are coupled with one another, in a reduced size.

The lift gear illustrated in FIGS. 1 to 3 incorporates a lift (1) and a counterweight (2), which run along paths that extend parallel to one another within a load-bearing construction (3), and which are connected to one another with the aid of one or preferably several main cables (4) that drive the lift (1).

The upper area of the load-bearing construction (3) incorporates a drive disc (6) and a diverting roller (5) for the main cable (4). It is however possible to incorporate only a drive disc without the said diverting roller.

The lift (1) and the counterweight (2) are each equipped with one internal weight compensation element (7, i.e. 8), with which a stabilising of the lift (1), i.e. the counterweight (2) can be effected.

The weight compensating elements (7 and 8) take the form of hanging cables. One end (9, i.e. 10) of the same is centrally affixed to the floor (11) of the lift (1), i.e. the floor (12) of the counterweight (2). The other end of the same (13, i.e. 14) is fixedly connected with the load-bearing construction (3) at a height that constitutes the centre point of the path (15) of the lift (1), i.e. of the counterweight (2).

The lift gear further incorporates a lift cable (16) that is equipped with power supply and/or function control lines for the lift (1), whereby the same serves for example for the supply of power to the lift or the drive, but also for the transmission of data for the function control and the function monitoring of the lift gear.

The lift cable (16) is combined with the weight compensating element (7, 8) of the lift, i.e. one is integrated into the other. In this way a construction incorporating the necessary dead weight, i.e. the compensating weight is created, which further incorporates a relatively large overall diameter, which in turn enables the incorporation of a greater number of power supply and/or function control lines within the said lift cable (16). In addition the total weight of the same ensures the compensating of the weight of the lift gear.

The lift gear illustrated in FIG. 4 differs from the gear illustrated in FIGS. 1 to 3 in that the weight compensating elements (7′, 8′) together with the lift cables (16′, 26′) combined with the same are each equipped with one slidingly affixed and suspended tensioning weight (17, i.e. 18) with which the weight compensating elements (7′ and 8′) can be supplied wit the tension that is necessary for a trouble-free operation. For reasons of convenience identical components of the gear have here been allocated identical reference numerals to those listed in FIGS. 1 to 3, whereby the latter have been affixed with an additional apostrophe. The counterweight (2′) is equipped not only with a weight compensating element (8′), but also with a lift cable (26′) that is combined with the former, with which for example a line connection with a lift drive can be created, which is not illustrated in detail here.

The weight compensating element (7, 8) with its integrated lift cable (16) of the lift illustrated in FIGS. 1 to 3, i.e. 4 consists of elements that are illustrated in detail in FIG. 5 and FIG. 6. As is clearly visible from these drawings the elements (19, 20) can be coupled to one another along their cross-section, for example with the aid of a groove and spring connection (21a, 21b). The element (19) incorporates a multitude of individual lines (22) of the lift cable (16), which fulfil the function of power supply and data transmission lines. The element (20) however, which is equipped with weights, lines, steel waste or similar components, is not equipped with such lines. It would however be possible according to the principles of the invention to provide further individual lines of the lift cable here. An element can further incorporate cables and lines as well as a weight. These strand-shaped elements can however also be loosely positioned adjacent to one another, and possibly also at a distance from one another.

The invention has been sufficiently described with the aid of the above embodiments. However, further embodiments are possible and could be illustrated. For example, the elements (19, 20) could be advantageously positioned adjacent to one another along their shorter sides and fixedly connected to one another with the aid of an adhesive.

Those elements or strands that incorporate an elongated, for example a rectangular cross-section can further be fixedly connected to the load-bearing construction, i.e. the shaft wall with their elongated cross-sectional sides, so that they can be curved around the said elongated sides.

1. Lift gear with one or several main cables (4), operating the lift (1) and connecting the same to a counterweight (2), a weight compensating element (7, 8) for stabilising the lift (1) and the counterweight (2) as well as at least one lift cable (16) provided for the power supply and/or function control lines for the lift, characterised in that the lift (1) and the counterweight (2) each incorporate at least one internal weight compensating element (7, i.e. 8), whereby the said weight compensating element (7) of the lift (1) is combined with the lift cable (16).

2. Lift gear according to claim 1, characterised in that the weight compensating elements (7, i.e. 8) of the lift (1) and of the counterweight (2) take the form of hanging cables, one end of which (9, i.e. 10) is fixedly connected to the lift (1), i.e. to the counterweight (2), and the other end (13, i.e. 14) to the load-bearing construction (3) of the lift gear or a shaft wall of the building.

3. Lift gear according to claim 2, characterised in that the fitting (13, 14) of the weight compensating elements (7, i.e. 8) on the load-bearing construction (3) or the shaft wall is positioned at a height that constitutes the centre point of the path (15) of the lift (1), i.e. of the counterweight (2).

4. Lift gear according to one of the preceding claims 1 to 3, characterised in that the counterweight (2) incorporates at least one weight compensating element (8′) and one lift cable (26′).

5. Lift gear according to one of the preceding claims 2 to 4, characterised in that the weight compensating elements (7′, i.e. 8′) are each equipped with a slidingly affixed and suspended tensioning weight (17, i.e. 18).

6. Weight compensating element with a combined lift cable for the lift of the lift gear according to one of the preceding claims 1 to 5, characterised in that the cross-section of the same incorporates several elements (19, 20) that are preferably coupled to one another, of which at least one is equipped with a multitude of individual lines (22) of the lift cable (16).

7. Weight compensating element with integrated lift cable according to claim 6, characterised in that the elements (19, 20) can be coupled with one another with the aid of a fitting medium such as for example a groove/spring connection (21a, 21b).

8. Weight compensating element with integrated lift cable according to claim 7, characterised in that the elements (19, 20) that incorporate an elongated, for example rectangular cross-section can further be fixedly connected to the load-bearing construction, i.e. the shaft wall with their elongated cross-sectional sides, so that they can be curved around the axis of these said elongated sides.

9. Weight compensating element with integrated lift cable according to claim 6, characterised in that the elements are loosely positioned adjacent to one another, and possibly also at a distance from one another.
